(19) United States
(12) Patent Application Publication
(10) Pub. No.: US 2012/0243101 A1
(43) Pub. Date: Sep. 27, 2012

(54) IMAGE CAPTURING DEVICE WITH MICRO-LENS ARRAY

(75) Inventors: Tomoaki Nagasaka, Tokyo (JP); Kouichi Nakagome, Tokyo (JP)

(73) Assignee: CASIO COMPUTER CO., LTD., Tokyo (JP)

(21) Appl. No.: 13/426,175

(22) Filed: Mar. 21, 2012

(30) Foreign Application Priority Data
Mar. 25, 2011 (JP) 2011-068369

(51) Int. Cl. G02B 27/12

(52) U.S. Cl. 359/619

(57) ABSTRACT

The noise occurring is made to decrease in a case of a reconstructed image being generated from a lightfield image captured by way of a plenoptic camera. An image capturing device 1 is equipped with a main lens 31, a micro-lens array 32 having a plurality of micro-lenses 32-i, and an imaging element 33. Each edge of the micro-lens 32-i in the micro-lens array 32 is systematically disposed to continuously repeat, so as to be in line contact with an edge of another micro-lens 32-i. An aperture shape of the main lens 31 has substantially the same shape as a shape of the micro-lens 32-i. The ratios of the length of each edge of the plurality of micro-lenses 32-i to a focal distance are substantially the same.

This application is based on and claims the benefit of priority from Japanese Patent Application No. 2011-068369, filed on Mar. 25, 2011, the content of which is incorporated herein by reference.

### BACKGROUND OF THE INVENTION

1. Field of the Invention

The present invention relates to an image capturing device called a plenoptic camera.

2. Related Art

In recent years, an image capturing device that introduces information for direction distribution of incident light rays, i.e. an image capturing device called a “plenoptic camera”, has been developed.

In the optical system of a plenoptic camera, a compound-eye lens array, in which microscopic lenses (hereinafter referred to as “micro-lenses”) are arranged to continuously repeat vertically and horizontally, is inserted between a conventional imaging lens (hereinafter referred to as “main lens”) and the imaging element.

The individual micro-lenses constituting the micro-lens array distribute light condensed by the main lens onto a plurality of pixels in the imaging element, depending on the angle at the light ray arrives.

In other words, the figure condensed on the imaging element by each of the individual micro-lenses (hereinafter referred to as “sub-image”) is a plurality of aggregates, and the data of the image constituted of an aggregate of this plurality of sub-images is output from the imaging element as the data of a captured image.

It should be noted that such a captured image of a plenoptic camera, i.e. image constituted of an aggregate of a plurality of sub-images, is referred to as a “lightfield image” hereinafter.

The lightfield image is generated by light irradiated through the conventional main lens, as well as the micro-lenses array in this way.

As a result, the lightfield image not only has spatial information of two-dimensions that is included in a conventional captured image, but as information not included in conventionally captured images, also has directional information of two-dimensions indicating what direction the arriving light rays are from when viewing from the imaging element.

As a result, after image capture of a lightfield image havng such two-dimensional directional information, the plenoptic camera can reconstruct the figure on a plane separated in front by any distance during image capture, using the data of this light field image.

In other words, even in a case of having captured a lightfield image without the plenoptic camera focusing at a predetermined distance, after image capturing, the plenoptic camera can freely produce data of an image (hereinafter referred to as a “reconstructed image”) equivalent to an image captured by focusing at this predetermined distance using the data of this lightfield image.

More specifically, the plenoptic camera sets one point on a plane separated by an arbitrary distance to an attention point, and calculates on which pixels in the imaging element the light from this attention point is distributed via the main lens and the micro-lens array.

In this regard, if each pixel of the imaging element corresponds to each pixel constituting the lightfield image, for example, then the plenoptic camera integrates the pixel value of at least one pixel on which light from the attention point is distributed, among each of the pixels constituting the lightfield image. This integral value becomes the pixel value of the pixel corresponding to the attention point in the reconstructed image. The pixel corresponding to the attention point in the reconstructed image is thereby reconstructed.

The plenoptic camera sequentially sets each pixel constituting the reconstructed image (each pixel corresponding to each point on a plane separated by an arbitrary distance from the plenoptic camera) to the attention point, respectively, and repeats the aforementioned sequence of processing, thereby reconstructing data of the reconstructed image (aggregate of pixel values of each pixel of the reconstructed image).

### SUMMARY OF THE INVENTION

According to a first aspect of the present invention, in an image capturing device equipped with an optical system including a main lens, a micro-lens array, and an imaging element, micro-lenses in the micro-lens array are regularly-arrayed so that an edge of one micro-lens in the micro-lens array is in line contact with an edge of another micro-lens.

### BRIEF DESCRIPTION OF THE DRAWINGS

A deeper understanding of the present application can be obtained when the following detailed explanation is considered in conjunction with the following drawings.

FIG. 1 is a diagram showing the hardware configuration of an image capturing device according to an embodiment of the present invention;

FIG. 2 is a diagram showing an example configuration of an optical system;

FIG. 3 is a flowchart illustrating reconstruction processing;

FIG. 4 is a diagram showing the configuration of the optical system of a conventional image capturing device;

FIG. 5 provides views for comparing between the reconstructed image obtained in the case of applying the present invention and a conventional reconstructed image; and

FIG. 6 is a diagram for comparing between the configurations of the optical systems of the image capturing device according to the present embodiment and a conventional image capturing device.

### DETAILED DESCRIPTION OF THE INVENTION

Hereinafter, an embodiment of the present invention will be explained based on the drawings.

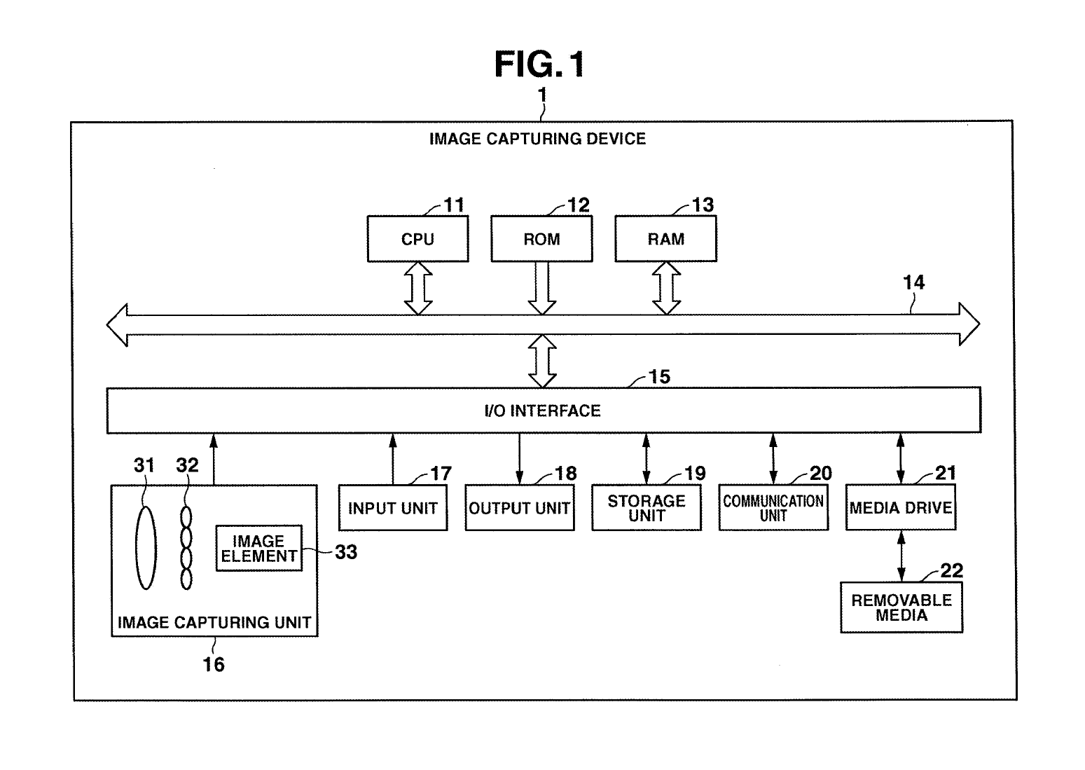

FIG. 1 is a block diagram showing the hardware configuration of an image capturing device 1 according to an embodiment of the present invention.

The image capturing device 1 includes a CPU (Central Processing Unit) 11, ROM (Read Only Memory) 12, RAM (Random Access Memory) 13, a bus 14, an I/O interface 15, an image capturing unit 16, an input unit 17, an output unit 18, a storage unit 19, a communication unit 20, and a media drive 21.

The CPU 11 executes a variety of processing in accordance with a program recorded in the ROM 12, or a program loaded from the storage unit 19 into the RAM 13.

The necessary data and the like upon the CPU 11 executing the variety of processing are also stored in the RAM 13 as appropriate.

The CPU 11, ROM 12 and RAM 13 are connected to each other through the bus 14. The I/O interface 15 is also connected to this bus 14. The image capturing unit 16, input unit 17, output unit 18, storage unit 19, communication unit 20 and media drive 21 are connected to the I/O interface 15.

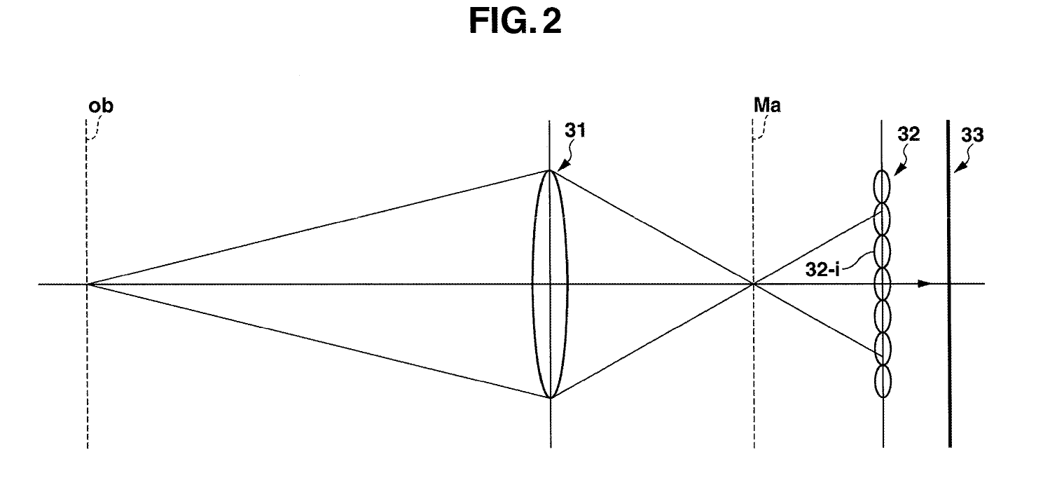

The image capturing unit 16 includes a main lens 31, a micro-lens array 32, and an imaging element 33. It should be noted that further details of the image capturing unit 16 will be explained later while referring to FIG. 2.

The input unit 17 is configured by a variety of buttons such as a shutter button (not shown), and inputs a variety of information in accordance with a command operation of the user.

The output unit 18 is configured by a monitor, speaker, etc., and outputs various images and various sounds.

The storage unit 19 is configured by a hard disk, DRAM (Dynamic Random Access Memory), or the like, and stores the data of various images such as light field images and reconstructed images, which are described later.

The communication unit 20 controls communication with other devices (not shown) via a network including the internet.

Removable media 22 consisting of magnetic disks, optical disks, magneto-optical disks, semiconductor memory, or the like, are installed in the media drive 21 as appropriate. Programs read from the removable media 22 by the media drive 21 are installed in the storage unit 19 as necessary. Similarly to the storage unit 19, the removable media 22 can also store a variety of data such as the data of images stored in the storage unit 19.

FIG. 2 is a schematic diagram showing an example configuration of the optical system in the image capturing device 1 having such a configuration.

In the optical system of the image capturing device 1, the main lens 31, micro-lens array 32, and imaging element 33 are arranged in this order, when viewed from an object surface ob, which is the photographic subject.

In the micro-lens array 32, each of N number (N is any integer value of at least 2) of micro-lenses 32-1 to 32-N is systematically arranged to continuously repeat.

The main lens 31 condenses luminous flux emitted from a light source, causing it to be imaged on a predetermined plane Ma, and causing to be incident on the micro-lens array 32. It should be noted that the plane Ma imaged by the main lens 31 is called the “main lens imaging plane Ma” hereinafter.

The micro-lens 32-i in the micro-lens array 32 (i is an integer value within the range of 1 to N) condenses the light flux incident from the object plane ob via the main lens 31 in every incident direction to cause a sub-image to form on the imaging element 33.

In other words, on the imaging element 33, a plurality of sub-images are formed by each of the plurality of micro-lenses 32-1 to 32-N, whereby a lightfield image, which is an aggregate of this plurality of sub-images, is generated.

Herein, a case of the image capturing device 1 generating the data of a reconstructed image from the data of a lightfield image resulting from capturing the object plane ob will be explained.

In this case, when setting one point of a figure on a forward plane separated from the main lens 31 by an arbitrary distance (when assuming there is a subject at a place separated from the main lens 31 by this arbitrary distance, the plane considered to be imaged by the main lens 31) to an attention point, the image capturing device 1 calculates on which pixels within the imaging element 33 the light from the attention point is distributed via the main lens 31 and the micro-lens array 32. It should be noted that the plane serving as the target of reconstruction, i.e. the plane on which the attention point is established, is called the “reconstructed plane”.

Then, the image capturing device 1 performs an estimation calculation of the pixel value of pixels corresponding to the attention point in the reconstructed image, by integrating the pixel values in the data of the light field image, corresponding to the distributed pixels.

The image capturing device 1 generates data of the reconstructed image by executing such an estimation calculation for each pixel of the reconstructed image.

It should be noted that the processing until the generation of the data of a reconstructed image by the image capturing device 1 in this way is referred to as “reconstruction processing” hereinafter.

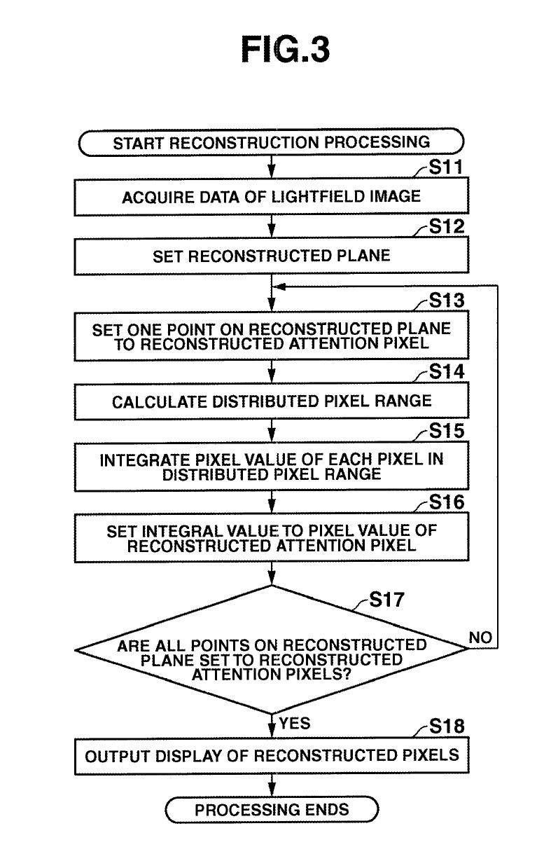

FIG. 3 is a flowchart illustrating the flow of the reconstruction processing executed by the image capturing device 1 of FIG. 1.

It should be noted that, prior to the reconstruction processing, the image capturing device 1 captures an image of the subject of photography, and stores data of the light field image obtained as a result thereof in the storage unit 19 or the like.

In Step S11, the CPU 11 of the image capturing device 1 acquires data of a light field image from the storage unit 19 or the like.

In Step S12, the CPU 11 sets a figure on a plane that is at a position separated a predetermined distance in front of the main lens 31 as the reconstructed plane.

In Step S13, the CPU 11 sets one point of the reconstructed plane to a reconstructed attention pixel.

In Step S14, the CPU 11 calculates a distributed pixel range for the reconstructed attention pixel. Distributed pixel range is a range of pixels in the imaging element 33 to which light from the reconstructed attention pixel is distributed via the main lens 31 and the micro-lens array 32, i.e. range of pixels in the lightfield image.

In Step S15, the CPU 11 integrates the pixel value of each pixel in the distributed pixel range.

In Step S16, the CPU 11 sets the integral value resulting from the processing of Step S15 to the pixel value of the reconstructed attention pixel.

In Step S17, the CPU 11 determines whether or not all points on the reconstructed plane have been set to the reconstructed attention pixel.

Among each of the points on the reconstructed plane, in a case of a point still not having been set to the reconstructed attention pixel existing, the CPU 11 determines NO in the processing of Step S17, returns the processing to Step S13, and repeats the processing from Step S13 and onward. In other words, each point on the reconstructed plane is sequentially set to the reconstructed attention pixel, and in each occurrence, loop processing of Step S13 to Step S17 is repeatedly executed, whereby the pixel values of the reconstructed attention pixels are set.

Data of the reconstructed image is generated by the pixel values of each pixel corresponding to each point on the reconstructed plane being respectively set in this way. The CPU 11 thereby determines YES in Step S17, and advances the processing to Step S18.

In Step S18, the CPU 11 outputs display of the reconstructed image from the output unit 18.

The reconstruction processing is thereby completed.

However, the prior art uses data of a lightfield image obtained by an image capturing device having a perfectly circular-shaped main lens 31 and perfectly circular micro-lenses 32-i in the optical system, by estimation calculation (hereinafter referred to as “reconstruction calculation”) of each pixel of the reconstructed image by way of such loop processing of Step S13 to Step 17.

As a result, if an object region having high spatial frequency does not exist in the reconstructed plane, periodic noise may occur in a region that should be a natural blur.

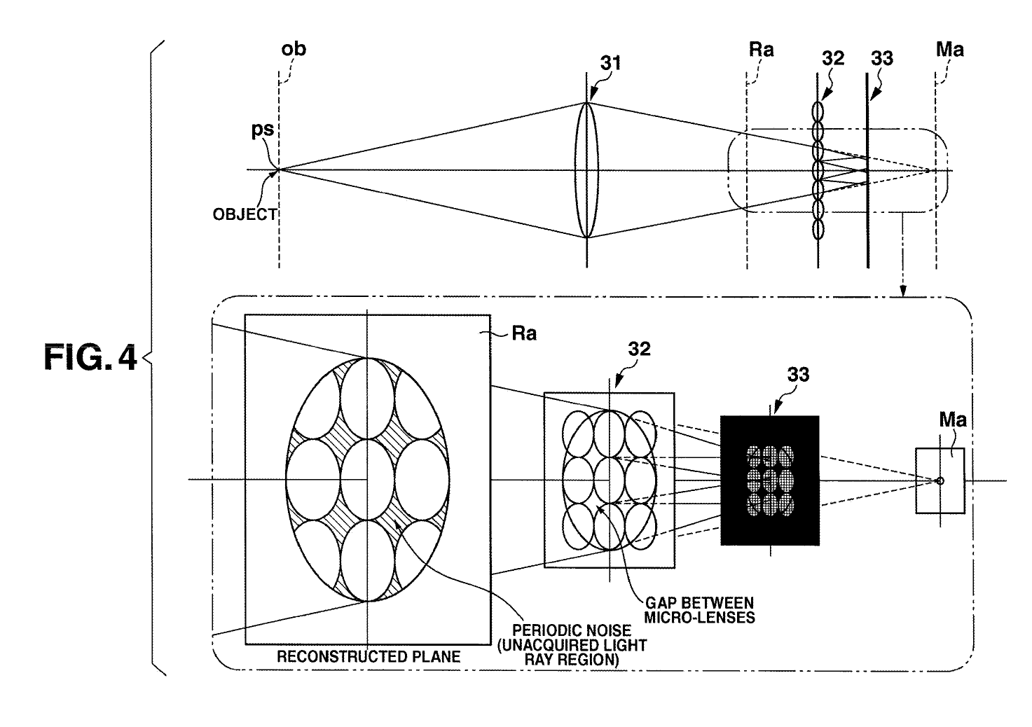

FIG. 4 is a schematic diagram for illustrating the main cause for periodic noise occurring, showing the configuration of the optical system of a conventional image capturing device.

It should be noted that the position of the object plane ob (object plane ob focused during image capturing) when the lightfield image was captured in FIG. 4 differs from the case of FIG. 2. As a result, the position of the main lens imaging plane Ma also differs from the case of FIG. 2, and is behind the imaging element 33.

When the lightfield image is captured, the light rays from a point-source light ps on the object plane ob is incident on the micro-lens array 32 through the main lens 31, as shown in FIG. 4. Among the light rays incident on such a micro-lens array 32, light rays having reached a region in which the micro-lenses 32-i are not arranged (hereinafter referred to as “gap between micro-lenses”) cannot penetrate this micro-lens array 32. Therefore, the light rays having reached a gap between micro-lenses do not reach the imaging element 33, and understandably do not condense on the imaging element 33 as a result (i.e. the light rays are not integrated as the intensity).

Although not illustrated in FIG. 4, in the case of assuming that the reconstructed plane is set at the same position as the main lens imaging plane Ma during the execution of the reconstruction processing (refer to Step S12 of FIG. 3), the light rays from the point-source light on the object plane ob would concentrate on one point on the reconstructed plane. As a result, the information of the light rays having reached a gap between micro-lenses (information lacking in the imaging element 33 due to not condensing on the imaging element 33) can be compensated by the information of light rays having reached the micro-lenses 32-i (information acquired at the imaging element 33 due to condensing on the imaging element 33). Due to this, periodic noise does not substantially occur in the reconstructed image.

However, as described in the foregoing, the reconstruction processing is processing that is executed with the purpose of obtaining data of a reconstructed image equivalent to an image focused on a different plane from the object plane ob that was focused during the capturing of the lightfield image. In this case, in order to assume the appearance “focused on a different plane from the object plane ob focused during capturing of the lightfield image”, the reconstructed plane Ra has been set at a position differing from the main lens imaging plane Ma, as shown in FIG. 4. As a result, the light rays having reached a gap between micro-lenses are not being condensed on the imaging element 33 (i.e. light rays not being integrated as intensity), and thus the information thereof cannot be used in reconstruction processing, a result of which periodic noise will occur in the reconstructed image.

As explained above, the main cause for periodic noise occurring in the reconstructed image is because of the gaps between micro-lenses existing.

Therefore, in order to mitigate this noise, the present inventors have devised a technique of reducing the gaps between micro-lenses more than the conventional optical system, by (1) establishing the shape of each of the micro-lenses 32-i constituting the micro-lens array 32 in a shape other than a perfectly circular shape (e.g., square shape), and (2) establishing the aperture shape of the main lens 31 as the same shape as the shape of the micro-lenses 32-i (e.g., square shape). Hereinafter, the above-mentioned techniques of (1) and (2) will be referred to as “techniques for reducing gap between micro-lenses”.

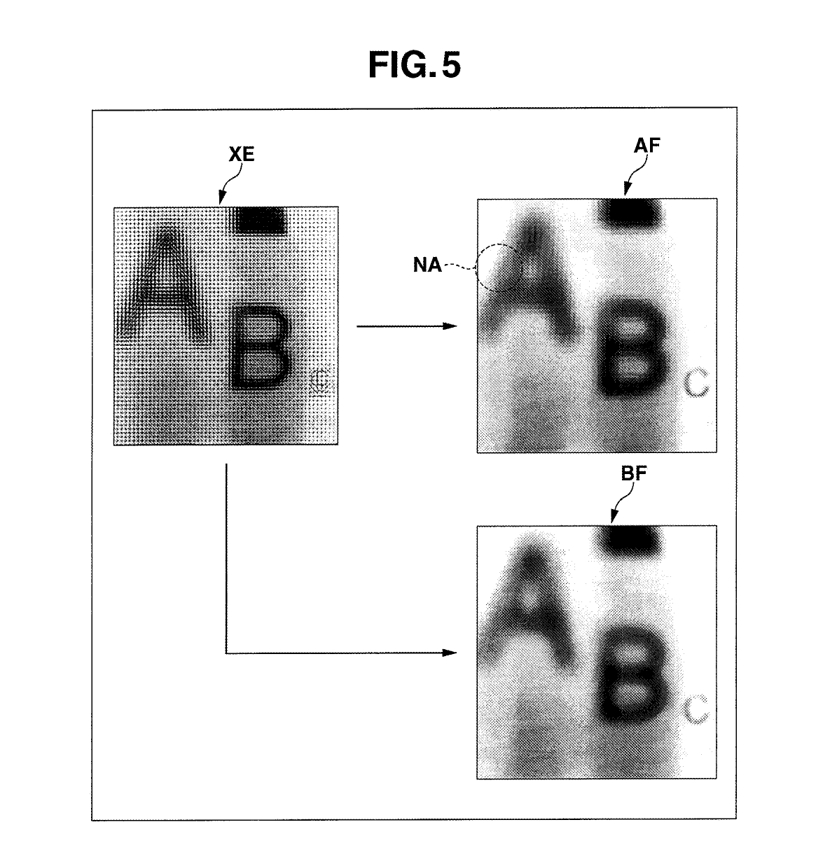

FIG. 5 provides views for comparing a reconstructed image obtained in a case of applying such techniques of reducing the gaps between micro-lenses according to the present invention and the reconstructed imaged obtained according to a case of applying a conventional technique.

Herein, the conventional technique refers to (1) establishing the shape of each of the micro-lenses 32-I constituting the micro-lens array 32 as a perfectly circular shape, and (2) establishing the aperture shape of the main lens 31 as a perfectly circular shape, similarly to the shape of the micro-lenses 32-i.

A lightfield image XE obtained by way of image capturing is shown in FIG. 5.

It should be noted that, although only one lightfield image XE is shown for simplicity of explanation, data of separate lightfield images for which the shapes of the sub-images are distinctly different is obtained in actual practice. In other words, although not illustrated, the shapes of the sub-images of the lightfield image obtained by the conventional technique are a perfectly circular shape, which is the shape of the conventional micro-lenses 32-i. In contrast, although not illustrated, in the case of applying the techniques of reducing the gap between micro-lenses according to the present invention, the shape of the lightfield image obtained as a result is a shape other an a perfectly circular shape (e.g., square shape).

The lightfield image XE is arrived at by image capturing a state in which a card labeled “A”, a card labeled “B”, and a card labeled “C” are each arranged to be incrementally separated by a fixed distance in order from nearest in front of the main lens 31. As shown in FIG. 5, at the moment of image capturing this lightfield image XE, the card labeled “B” is mostly focused.

In the present example, reconstruction processing is executed so that a reconstructed image equivalent to being focused on the card labeled “C” is obtained.

A reconstructed image AF obtained in a case of applying the conventional technique is shown in FIG. 5.

In the reconstructed image AF, periodic noise occurs in the spatial direction such as in the region NA.

In addition, a reconstructed image BF obtained in a case of applying the techniques of reducing the gap between micro-lenses according to the present invention is shown in FIG. 5.

In the reconstructed image BF, periodic noise in the spatial direction does not substantially occur, the card labeled “C” is focused, and the other respective figures of cards labeled “A” and “B” can be seen to become blurred images (ideal images without noise).

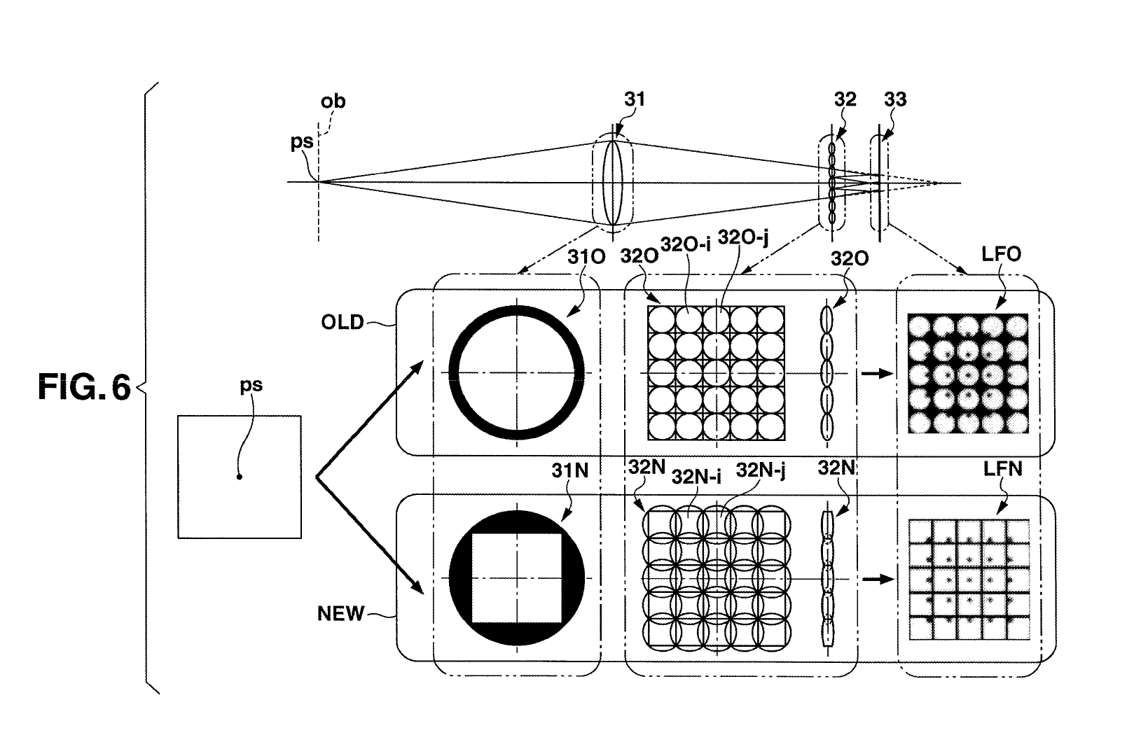

FIG. 6 is a diagram for comparing between the configurations of the optical systems of the image capturing device 1 according to the present embodiment in which the techniques of reducing gaps between the micro-lenses according to the present invention are applied, and a conventional image capturing device.

In FIG. 6, the optical system having the main lens 31O and micro-lens array 32O is similar to a conventional image capturing device. When such a conventional image capturing device captures light rays from the point-source light ps on the object plane ob (due to the same figure being converted to a monochrome image, they become dark grey dots), data of the lightfield image LFO is obtained as a result.

The shape of each of the micro-lenses 32O-i constituting the micro-lens array 32O of the conventional image capturing device is a perfectly circular shape. In this case, when the micro-lens array 32O is divided into a grid pattern of a plurality of squares, the perfectly circular micro-lens 32O-i are in a state inscribed inside of this square grid pattern. In addition, the aperture shape of the main lens 31O is a perfectly circular shape, similarly to the micro-lenses 32O-i.

As a result, since a micro-lens 32O-i and a micro-lens-j adjacent thereto come into point contact, the area of the gap between micro-lenses becomes great. In the lightfield image LFO captured by the conventional image capturing device having an optical system of a configuration in which the area of the gaps between micro-lenses increases, regions are generated in which information of light rays having reached the gaps between the micro-lenses is lost (black regions of gaps between sub-images in FIG. 6). When reconstruction processing is executed using the data of such a lightfield image LFO, periodic noise occurs in the reconstructed image resulting therefrom (refer to reconstructed image AF in FIG. 5).

In contrast, in FIG. 6, an optical system having a main lens 31N and micro-lens array 32N is that of the image capturing device 1 of the present embodiment. When such an image capturing device 1 of the present embodiment captures light rays from the point-source light ps on the object plane ob (for simplicity of explanation, made black points in the same figure by monochrome inversion), the data of the lightfield image LFN is obtained as a result.

The shape of each of the micro-lenses 32N-i constituting the micro-lens array 32N in the image capturing device 1 of the present embodiment is a square shape. In this case, when the micro-lens array 32N is divided into a grid pattern of a plurality of squares, the perfect circles circumscribe this square grid pattern, and the square-shaped portions of this perfect circle included in the grid pattern function as the lens. In addition, the aperture shape of the main lens 31N is a square shape, similarly to the micro-lenses 32N-i.

As a result, a micro-lens 32N-i and a micro-lens 32N-j adjacent thereto come into line contact; therefore, the gaps between micro-lenses are almost eliminated. In the lightfield image LFN captured by the image capturing device 1 of the present embodiment having an optical system of a configuration substantially without gaps between micro-lenses, the information of light rays having reached the micro-lens array 32 is embedded without substantial loss or leakage. When reconstruction processing is executed using the data of such a lightfield image LFN, almost no periodic noise occurs in the reconstructed image resulting therefrom (refer to reconstructed image BF in FIG. 5), and outside the figure focused by the reconstruction becomes a blurred image (ideal image without noise).

As explained above, the image capturing unit 16 of the image capturing device 1 according to the present embodiment includes an optical system containing the main lens 31 having the aperture shape of a square shape, the micro-lens array 32 consisting of N number of micro-lenses 32-1 to 32-N of square shape, and the imaging element 33.

When data of the reconstructed image is generated from data of a lightfield image captured by the image capturing device 1 of such a configuration, the periodic noise that occurs conventionally is suppressed.

It should be noted that the present invention is not to be limited to the aforementioned embodiment, and that modifications, improvements, etc. within a scope that can achieve the object of the present invention are included in the present invention.

For example, in the aforementioned embodiment, although an explanation is provided with an optical system of a configuration in which (1) the shapes of each of the micro-lenses 32-i constituting the micro-lens array 32 are established as square shapes, and (2) the aperture shape of the main lens 31 is also established as a square shape, similarly to the shape of the micro-lenses 32-i, the configuration of the optical system is not limited thereto. In other words, it is sufficient so long as being a configuration of the optical system that can reduce the area of the gaps between micro-lenses, compared to the conventional case of using perfect circle micro-lenses 32-i, etc.

More specifically, for the micro-lens array 32, so long as being an optical system such that each edge of the micro lens 32-i in the micro-lens array 32 is systematically arranged to continuously repeat so as to make line contact with the edge of another micro-lens 32-j, and the aperture shape of the main lens 31 has substantially the same shape as the shape of the micro-lens 32-i, it can be applied to the image capturing device according to the present invention.

In other words, it is not particularly necessary for the shape of the micro-lens 32-i to be a square shape, and may be a polygonal shape such as a hexagon, for example.

However, if data of a lightfield image is obtained in which gaps between sub-images occur and overlap, there is concern over periodic noise occurring in the data of the reconstructed image generated from the data of this lightfield image.

Therefore, in order to avoid such a concern, the ratio between the length of each edge of the plurality of micro-lenses 32-i (if a polygonal shape such as a square shape, each side) and the focal length is desirably set to be the same. This is because it means that an effect is exerted equivalent to the F number of the micro-lens 32-i being made to match the main lens 31 in the case of the micro-lens 32-i shape being a perfect circle, i.e. the ratio between the focal length and the effective aperture being made to match.

Although an embodiment of the present invention has been explained above, this embodiment is merely an exemplification, and is not to limit the technical scope of the present invention. The present invention can assume various other embodiments, and furthermore, various modifications such as omissions and substitutions can be made within a scope not deviating from the gist of the present invention. These embodiments and modifications thereof are included in the scope and gist of the invention described in the present specification, and are included in the scope of the invention recited in the claims and equivalents thereof.

What is claimed is:

1. An image capturing device equipped with an optical system including a main lens, a micro-lens array, and an imaging element,
wherein micro-lenses in the micro-lens array are regularly-arrayed so that an edge of one micro-lens in the micro-lens array is in line contact with an edge of another micro-lens.

2. The image capturing device according to claim 1, wherein an aperture shape of the main lens is the same shape as a shape of the micro-lens.

3. The image capturing device according to claim 2, wherein the aperture shape of the main lens and the shape of the micro-lens are a square shape.

4. The image capturing device according to claim 1, wherein ratios of a length of each edge of the micro-lenses to a focal distance are the same.
